(19) United States
(12) Patent Application Publication
(10) Pub. No.: US 2016/0041127 A1
(43) Pub. Date: Feb. 11, 2016

(54) SUPPORT STRUCTURE LOCATION AND LOAD MEASUREMENT

(71) Applicant: ATOMIC ENERGY OF CANADA LIMITED, Chalk River (CA)

(72) Inventors: James M. KING, Deep River (CA); Paul A. FEENSTRA, Deep River (CA); Andrew B. KITTMER, Deep River (CA)

(73) Assignee: ATOMIC ENERGY OF CANADA LIMITED, Chalk River, ON (CA)

(21) Appl. No.: 14/781,009

(22) PCT Filed: Mar. 28, 2014
(86) PCT No.: PCT/CA2014/050322

§ 371 Date: Sep. 28, 2015

Related U.S. Application Data
(60) Provisional application No. 61/806,225, filed on Mar. 28, 2013.

(51) Int. Cl. G01N 29/04; G01N 29/24; G01L 1/10; G01N 29/12

(52) U.S. Cl. CPC G01N 29/043; G01N 29/12; G01N 29/2437; G01L 1/10; G01N 2291/0289; G01N 2291/014; G01N 2291/023

(57) ABSTRACT

A tool may be inserted into the pressure tube inside a calandria tube of a fuel channel of a nuclear reactor. Once in position, the tool may act to generate information useful for determining a location for an annulus spacer. Once the annulus spacer has been located, the tool may act to generate information useful for determining a compressive load on the annulus spacer due to the annulus spacer being pinched between the two tubes. In both the locating and the load determining, the tool may act to isolate a section of the pressure tube, excite the isolated section of the pressure tube with vibrations and measure resultant tube vibrations. Tube vibration characteristics, determined from the vibrations, may then be analyzed to determine an axial location along the pressure tube for the annulus spacer and/or determine a load on the annulus spacer.

### FIELD

This application claims the benefit of and priority to U.S. Provisional patent application Ser. No. 61/806,225, filed Mar. 28, 2013, under the title SUPPORT STRUCTURE LOCATION AND LOAD MEASUREMENT The content of the above patent application is hereby expressly incorporated herein by reference into the detailed description hereof.

The present application relates generally to analysis and maintenance of tubes and, more specifically, to location of, and to measurement of load on, a support structure external to a tube.

### BACKGROUND

It is conventional in some nuclear reactors for bundles of fuel to pass through the reactor within horizontal pressure tubes. Each pressure tube is surrounded by a calandria tube. Annulus spacers maintain a radial spacing between the pressure tube and the calandria tube and allow the calandria tube to support the pressure tube.

### BRIEF DESCRIPTION OF THE DRAWINGS

Reference will now be made, by way of example, to the accompanying drawings which show example implementations; and in which:

FIG. 1 illustrates a fuel channel including a calandria tube separated from a pressure tube by a loose-fit annulus spacer;

FIG. 2 illustrates a fuel channel including a calandria tube separated from a pressure tube by a snug-fit annulus spacer;

FIG. 3 illustrates a tool for insertion into the pressure tube of either FIG. 1 or FIG. 2 to locate an annulus spacer and measure a load on the located annulus spacer; and

FIG. 4 illustrates the tool of FIG. 3 inserted into a pressure tube.

### DETAILED DESCRIPTION

A tool may be inserted into the pressure tube of a fuel channel. Once in position, the tool may act to generate information useful for determining a location for an annulus spacer. Once the annulus spacer has been located, the tool may act to generate information useful for determining a load on the annulus spacer. In both the locating and the load determining, the tool may act to isolate a section of the pressure tube, excite the isolated section of the pressure tube with vibrations and measure resultant tube vibration characteristics. The tube vibration characteristics may then be analyzed to determine an axial location along the pressure tube for the annulus spacer and/or determine a load on the annulus spacer.

According to an aspect of the present disclosure, there is provided a tool adapted to be positioned within a tube. The tool includes a tool body, a first clamping block assembly located at a first end of the tool body, the first clamping block assembly including first clamping members that, when actuated, apply pressure against an inside surface of the tube, a second clamping block assembly located at a second end of the tool body, the second clamping block assembly including second clamping members that, when actuated, apply pressure against the inside surface of the tube, a bearing pad mounted to the tool body, the bearing pad adapted to contact the inside surface of the tube when the tool has been positioned within the tube, an actuator adapted to apply, via the bearing pad, a vibratory force to the inside surface of the tube when the tool has been positioned within the tube, a first accelerometer mounted to the tool body, the first accelerometer adapted to contact the inside surface of the tube at a first circumferential position when the tool has been positioned within the tube, a second accelerometer mounted to the tool body, the second accelerometer adapted to contact the inside surface of the tube at a second circumferential position when the tool has been positioned within the tube, the second circumferential position approximately diametrically opposed to the first circumferential position and a cable adapted to transfer instructions from a control system to the tool and adapted to transfer output from the accelerometers to the control system.

According to an aspect of the present disclosure, there is provided a method for locating a spacer surrounding a tube. The method includes isolating a section of the tube, exciting the isolated section of the tube with vibrations, measuring resultant tube vibrations, determining, from the resultant tube vibrations, tube vibration characteristics and analyzing the tube vibration characteristics to determine an axial location along the tube for the spacer.

According to another aspect of the present disclosure, there is provided a method for measuring load on a spacer surrounding a tube. The method includes isolating a section of the tube, exciting the isolated section of the tube with vibrations, measuring resultant tube vibrations, determining, from the resultant tube vibrations, tube vibration characteristics and analyzing the tube vibration characteristics to determine a load on the spacer.

According to a further aspect of the present disclosure, there is provided a system including a control system, an umbilical cable and a tool connected to the control system by the umbilical cable. The tool includes a tool body, a first clamping block assembly located at a first end of the tool body, the first clamping block assembly including first clamping members that, when actuated, apply pressure against an inside surface of the tube, a second clamping block assembly located at a second end of the tool body, the second clamping block assembly including second clamping members that, when actuated, apply pressure against the inside surface of the tube, a bearing pad mounted so as to contact the inside surface of the tube when the tool has been positioned within the tube, an actuator adapted to apply, via the bearing pad, a vibratory force to the inside surface of the tube when the tool has been positioned within the tube, a first accelerometer mounted to the tool body, the first accelerometer adapted to contact the inside surface of the tube at a first circumferential position when the tool has been positioned within the tube and a second accelerometer mounted to the tool body, the second accelerometer adapted to contact the inside surface of the tube at a second circumferential position when the tool has been positioned within the tube, the second circumferential position approximately diametrically opposed to the first circumferential position. The umbilical cable is adapted to transfer instructions from the control system to the tool and adapted to transfer output from the accelerometers to the control system.

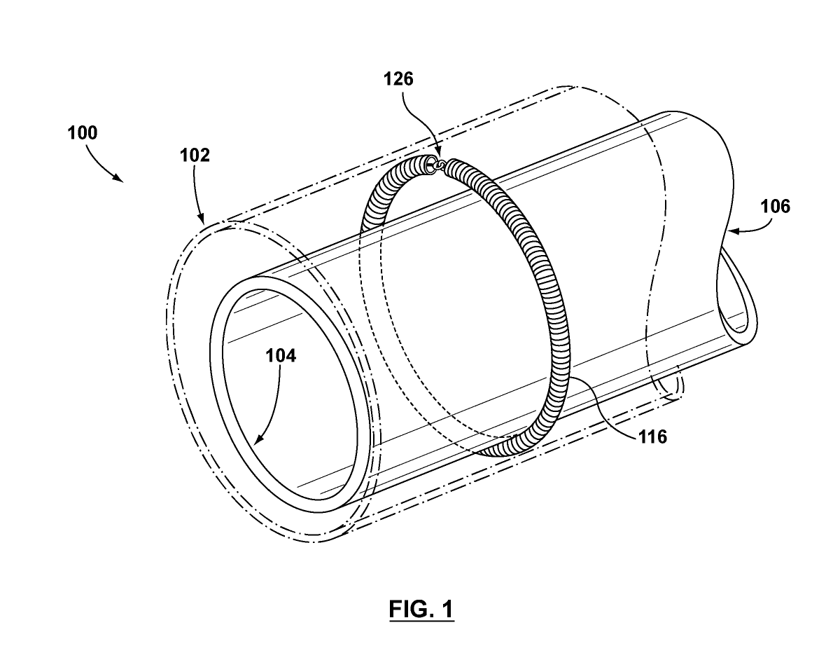

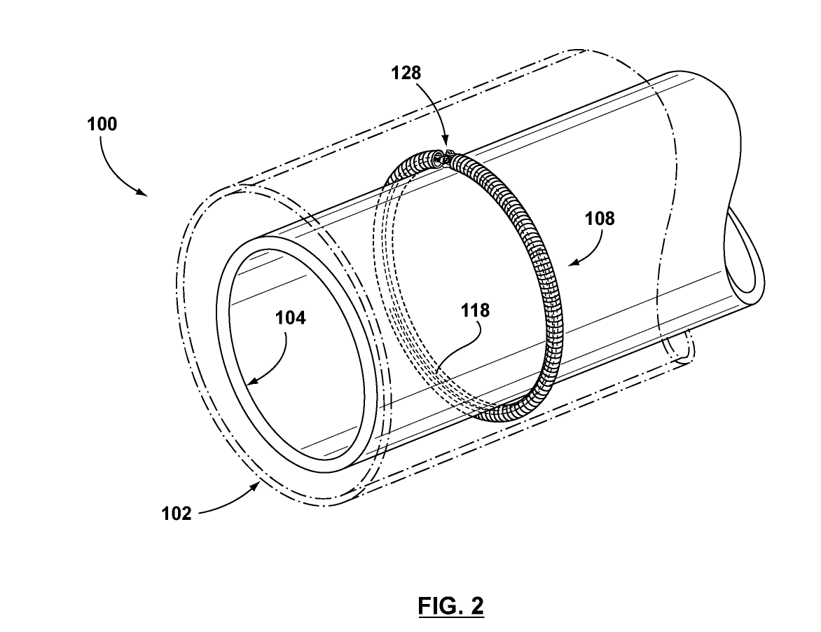

FIG. 1 illustrates a Calandria tube 102 surrounding a pressure tube 104. FIG. 2 also illustrates the Calandria tube 102 surrounding the pressure tube 104. Together, the calandria tube 102 and the pressure tube 104 form a fuel channel 100.

In general, two different types of annulus spacers are installed in reactors today. A “loose-fit” annulus spacer 106 is shown in FIG. 1. A “snug-fit” annulus spacer 108 shown in FIG. 2.

As illustrated in FIG. 1, the loose-fit annulus spacer 106 is a torus formed of a closely coiled spring 116 assembled on a circular girdle wire 126. The spring 116 may be made from a square cross-section wire. The ends of the girdle wire 126 may be welded together and sized to fit loosely on the pressure tube 104.

As illustrated in FIG. 2, the snug-fit annulus spacer 108 is a torus formed of a closely coiled spring 118 assembled on a circular girdle wire 128. The spring 118 may be made from a square cross-section wire. The ends of the girdle wire 128 may be hooked together to produce a snug fit on the pressure tube 104.

Typically, four spacers 106, 108 are used in the fuel channel 100, each annulus spacer 106, 108 at a different axial position along the pressure tube 104. To provide the optimum support, the annulus spacers 106, 108 may be located at specific positions. If one of the annulus spacers 106, 108 is out of position, the hot pressure tube 104 may come into contact with the cooler calandria tube 102.

In addition to maintaining proper position, it is advantageous when the annulus spacer 106, 108 maintain their structural integrity throughout the operating life of the reactor in which the annulus spacers 106, 108 are employed. Mechanical failure of one or more of the annulus spacers 106, 108 may have detrimental effects. Such detrimental effects include allowing contact between the pressure tube 104 and the calandria tube 102. Such detrimental effects also include causing fretting of the surfaces of the pressure tube 104 and the calandria tube 102.

Assessment of the integrity of installed annulus spacers 106, 108 is based upon current knowledge of in-reactor degradation mechanisms, including irradiation. Ongoing research into irradiated material properties has yielded useful data; however, concerns still exist because representative mechanical testing of post-service spacers has been limited. Since the annulus spacers 106, 108 are located in an area that is inaccessible, the annulus spacers 106, 108 can only be removed for inspection during a fuel channel replacement. Inconveniently, removal of the annulus spacers 106, 108 frequently results in damage to the annulus spacers 106, 108.

As the pressure tube 104 creeps and sags in service, loads are distributed among the four annulus spacers 106, 108. Consequently, the annulus spacers 106, 108 become pinched between the pressure tube 104 and the calandria tube 102, some more than others. Analytical (finite element) models for creep and sag can be used to calculate this load distribution and conservatively estimate maximum spacer operating loads.

To validate such analytical models for creep and sag and, thereby, determine more realistic maximum spacer operating loads, measurement of in-service annulus spacer loads is desirable. Such measurement of in-service annulus spacer loads has the potential to allow the spacer design margin of safety to be calculated with greater accuracy and has the potential to allow the production of better predictions of a gap between the pressure tube 104 and the calandria tube 102. The ability to verify if/when the annulus spacers 106, 108 are loaded is also desirable. The ability to verify if/when the annulus spacers 106, 108 are loaded may provide valuable information regarding spacer mobility, since a loaded annulus spacer 106, 108 may be considered less likely to move out of position that an annulus spacer 106, 108 that is not loaded.

Inconveniently, without actual measurement data, the analytical models for calculating load on the annulus spacers 106, 108 cannot be validated. This lack of validation leads to uncertainty and the use of over-conservative assumptions when assessing integrity and possible mobility of the annulus spacers 106, 108. As a result of these over-conservative assumptions, unnecessary operating restrictions and/or unnecessary maintenance restrictions may be placed on a reactor.

With ongoing research of in-reactor degradation mechanisms, the inability to measure load on the annulus spacers 106, 108 may lead to fuel channel replacements or the decreased operating life of a reactor.

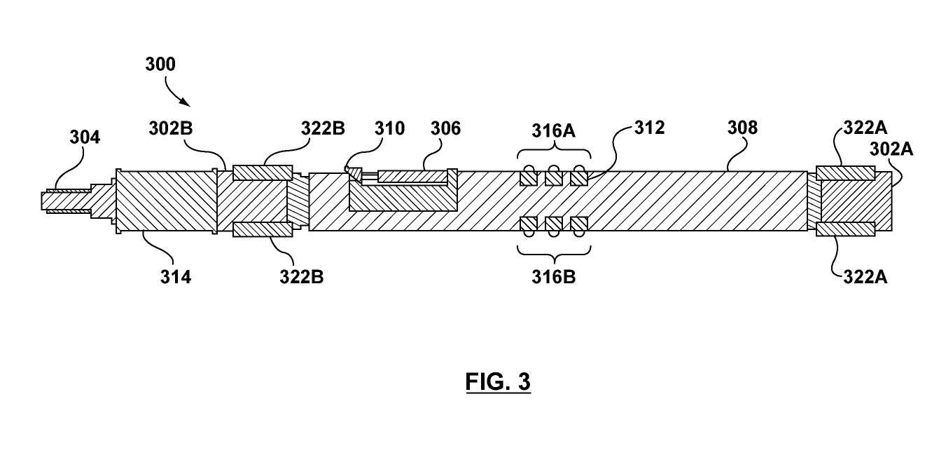

The approach is based around a tool 300 (see FIG. 3) that is inserted inside the pressure tube 104. The tool 300 is used while the reactor is shut down and the specific fuel channel 100 has been defueled. The tool 300 is delivered into the fuel channel 100 using standard, existing delivery machines (not shown). The delivery machine provides a mechanical interface for positioning the tool 300. An umbilical cable 304, with appropriate electrical cables and hydraulic hoses, connects the in-reactor tool 300 to an out-of-reactor control system (not shown). The out-of-reactor control system includes a hydraulic power supply (pump, valves), electrical power supplies, signal conditioning for transducers, data acquisition capabilities, data analysis capabilities and an operator interface. The tool 300 contains a number of actuators and sensors that are used for completing the spacer detection and load measuring operations. The tool 300 is designed to be used in a wet environment. The tool 300 and control system form a system that can detect the position of an annulus spacer 106, 108 and measure the load acting on the annulus spacer 106, 108.

The tool 300 includes a first clamping block assembly 302A, located at an end of the tool 300 distal from the point at which the umbilical cable 304 connects to the tool 300, and a second clamping block assembly 302B, located at an end of the tool 300 that is proximate to the point at which the umbilical cable 304 connects to the tool 300. The first clamping block assembly 302A includes first clamping members 322A. The second clamping block assembly 302B includes second clamping members 322B. The first clamping block assembly 302A and the second clamping block assembly 302B may be formed of stainless steel.

A main tool body 308, which may be formed of stainless steel, connects the first clamping block assembly 302A to the second clamping block assembly 302B.

A delivery machine interface 314 may physically couple the umbilical cable 304 to the second clamping block assembly 302B. The delivery machine interface 314 may contain electrical and hydraulic connections.

The tool 300 includes a piezo-electric actuator 306 mounted within the main tool body 308 and associated with a bearing pad 310. The bearing pad 310 is mounted to the piezo-electric actuator 306 so that, when the tool 300 has been inserted inside the pressure tube 104, the bearing pad 310 bears against the inside surface of the pressure tube 104 and against the main tool body 308.

The tool 300 includes a first plurality of accelerometers 312A mounted to the main tool body 308 at a first circumferential position. The tool 300 also includes a second plurality of accelerometers 312B mounted to the of the main tool body 308 at a second circumferential position, the second circumferential position being approximately diametrically opposed to the first circumferential position. The accelerometers 312 are biased so that, when the tool 300 has been inserted inside the pressure tube 104, the accelerometers 312 press against the inside surface of the pressure tube 104. The accelerometers 312 are biased by biasing elements, a representative one of which is associated, in FIG. 3, with reference numeral 312. An example biasing element 312 is a spring. In one embodiment of the present application, the tool 300 is inserted inside the pressure tube 104 with an orientation such that the first plurality of accelerometers 312A contact the inside surface of the pressure tube 104 at the top of the pressure tube 104 and the second plurality of accelerometers 312B contact the inside surface of the pressure tube 104 at the bottom of the pressure tube 104.

### Spacer Detection

Each annulus spacer 106, 108 is expected to contact the calandria tube 102 near the bottom of the calandria tube 102 and each annulus spacer 106, 108 is expected to only transmit force to the pressure tube 104 at the bottom of the pressure tube 104.

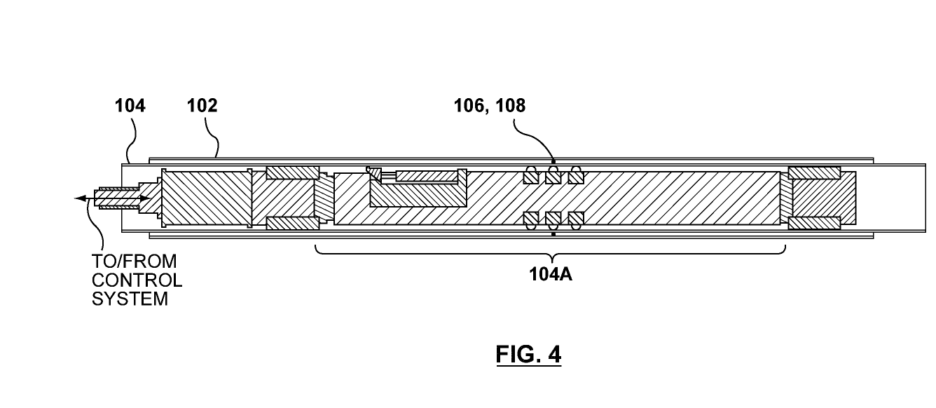

Before operation, a delivery machine (not shown) is controlled to deliver the tool 300 into the pressure tube 104 of the fuel channel 100 (see FIG. 4). Through control instructions, transferred from the control system to the tool 300 via the umbilical cable 304, the first clamping block assembly 302A and the second clamping block assembly 302B are controlled to apply pressure, with their respective clamping members 322A, 322B, against the inside surface of the pressure tube 104. This application of pressure acts to form an isolated section 104A of the pressure tube 104. The isolated section 104A has a fixed “vibrating length.” The isolated section 104A is isolated from vibrations from the part of the pressure tube 104 not included in the isolated section 104A.

The clamping block assemblies 302 may, for example, use hydraulic fluid received via the umbilical cable 304 to press their respective clamping members 322A, 322B against the inner circumference of the inside surface of the pressure tube 104. In an alternate embodiment, an electric motor-driven mechanism may be used by the clamping block assemblies 302 to press their respective clamping members 322A, 322B against the inside surface of the pressure tube 104. The clamping members 322 may, for example, be formed of an aluminum bronze alloy.

In operation, responsive to instructions from the control system, an amplifier (not shown) and a signal generator (not shown) control the piezo-electric actuator 306 to apply, via the bearing pad 310, a vibratory force to the inside surface of the pressure tube 104. Based on specific excitation by the amplifier and the signal generator, the vibratory force applied by the piezo-electric actuator 306 has a desired frequency and a desired amplitude. For example, the desired amplitude may be a low amplitude shell mode vibration.

As is known, “shell mode” vibration in a round tube section involves displacements of the tube wall away from its nominal circular cross-section, while the ends of the tube section remain fixed. “Low amplitude” vibrations may be defined as having a peak acceleration that is less than 2 g.

Subsequent to the application of the vibratory force by the piezo-electric actuator 306, the accelerometers 312 function to detect resultant motion of the pressure tube 104. Digital representations of the motion detected by the accelerometers 312 are then transferred to the control system via the umbilical cable 304.

More particularly, some of the accelerometers 312 measure resultant vibrations in the pressure tube 104 (sometimes termed a “pressure tube response”) at the top of the pressure tube 104 and some of the accelerometers 312 measure the pressure tube response at the bottom of the pressure tube 104.

The presence of an annulus spacer 106, 108 is expected to alter deflection of the wall of the pressure tube 104 in a location local to the annulus spacer 106, 108.

In use, the tool 300 may be positioned at a desired axial location along the length of the pressure tube 104 while the piezo-electric actuator 306 excites a shell mode vibration in the pressure tube 104.

A comparison between the movement of the pressure tube 104 detected at the top of the pressure tube 104 and the movement of the pressure tube 104 detected at the bottom the pressure tube 104 is performed to identify spacer locations. If the annulus spacer 106, 108 is not under load, the ratio of acceleration measured at the bottom of the pressure tube 104 to the acceleration measured at the top of the pressure tube 104 equals 1. When the annulus spacer 106, 108 is under load, the acceleration at the bottom of the pressure tube 104 is most suppressed at the location of the annulus spacer 106, 108. Consequently, the ratio is lowest at the location of the annulus spacer 106, 108.

### Spacer Load Measurement

Once a position is determined for an annulus spacer 106, 108, a load measurement is achieved by vibrating the isolated section 104A of the pressure tube 104 in a controlled manner.

To measure load on an annulus spacer 106, 108, the tool 300 is positioned, by the delivery machine, at a desired location with respect to the annulus spacer 106, 108.

Through control instructions, transferred from the control system to the tool 300 via the umbilical cable 304, the first clamping block assembly 302A and the second clamping block assembly 302B are controlled to apply pressure, with their respective clamping members 322A, 322B, against the inside surface of the pressure tube 104. This application of pressure acts to form an isolated section 104A of the pressure tube 104. The isolated section 104A has a fixed “vibrating length.” The isolated section 104A is isolated from vibrations from the part of the pressure tube 104 not included in the isolated section 104A.

Responsive to instructions from the control system, the amplifier and the signal generator control the piezo-electric actuator 306 to apply, via the bearing pad 310, a vibratory force to the inside surface of the pressure tube 104. Based on specific excitation by the amplifier and the signal generator, the vibratory force applied by the piezo-electric actuator 306 has a desired frequency and a desired amplitude. For example, the desired amplitude may be a low amplitude shell mode vibration.

Subsequent to the application of the vibratory force by the piezo-electric actuator 306, the accelerometers 312 function to detect resultant motion of the pressure tube 104. Digital representations of the motion detected by the accelerometers 312 are then transferred to the control system via the umbilical cable 304.

Some of the accelerometers 312 measure the pressure tube response at the top of the pressure tube 104 and some of the accelerometers 312 measure the pressure tube response at the bottom of the pressure tube 104.

The digital representations of the motion detected by the accelerometers 312 may be used by the control system to determine “pressure tube vibration characteristics.”

The magnitude of a load on the annulus spacer 106, 108 may be determined through analysis, performed at the control system, of pressure tube vibration characteristics that are expected to vary with load.

These pressure tube vibration characteristics may be seen to include multiple sets of parameters. One set of parameters are natural frequencies. Another parameter may be pressure tube vibration amplitude at the location of the annulus spacer 106, 108. Both of these parameters change as a function of load on the annulus spacer 106, 108. An empirical relationship or calibration curve may be used to relate the pressure tube vibration characteristics to a specific load on the annulus spacer 106, 108.

In summary, then, locating the annulus spacer 106, 108 involves isolating a section of the pressure tube 104, exciting the isolated section of the pressure tube 104 with vibrations, measuring resultant tube vibrations, determining tube vibration characteristics and analyzing the tube vibration characteristics to determine an axial location along the pressure tube 104 for the annulus spacer 106, 108. Once the annulus spacer 106, 108 has been located, determining the load on the annulus spacer 106, 108 involves isolating a section of the pressure tube 104, exciting the isolated section of the pressure tube 104 with vibrations, measuring resultant tube vibrations, determining tube vibration characteristics and analyzing the tube vibration characteristics to determine a load on the annulus spacer 106, 108.

Other aspects and features of the present disclosure will become apparent to those of ordinary skill in the art upon review of the following description of specific implementations of the disclosure in conjunction with the accompanying figures.

The above-described implementations of the present application are intended to be examples only. Alterations, modifications and variations may be effected to the particular implementations by those skilled in the art without departing from the scope of the application, which is defined by the claims appended hereto.

What is claimed is:

1. A tool adapted to be positioned within a tube, the tool comprising:
a tool body;
a first clamping block assembly located at a first end of the tool body, the first clamping block assembly including first clamping members that, when actuated, apply pressure against an inside surface of the tube;
a second clamping block assembly located at a second end of the tool body, the first clamping block assembly including second clamping members that, when actuated, apply pressure against the inside surface of the tube;
a bearing pad mounted so as to contact the inside surface of the tube when the tool has been positioned within the tube;
an actuator adapted to apply, via the bearing pad, a vibratory force to the inside surface of the tube when the tool has been positioned within the tube;
a first accelerometer mounted to the tool body, the first accelerometer adapted to contact the inside surface of the tube at a first circumferential position when the tool has been positioned within the tube;
a second accelerometer mounted to the tool body, the second accelerometer adapted to contact the inside surface of the tube at a second circumferential position when the tool has been positioned within the tube, the second circumferential position approximately diametrically opposed to the first circumferential position; and
a cable adapted to transfer instructions from a control system to the tool and adapted to transfer output from the accelerometers to the control system.

2. The tool of claim 1 further comprising a biasing element for biasing the accelerometer against the inside surface of the tube when the tool has been positioned within the tube.

3. The tool of claim 1 wherein the actuator comprises a piezo-electric actuator.

4. The tool of claim 1 wherein the first clamping block assembly further comprises hydraulic actuators for forcing the first clamping members to apply pressure against the inside surface of the tube.

5. The tool of claim 1 wherein the first clamping block assembly further comprises an electric motor-driven mechanism for forcing the first clamping members to apply pressure against the inside surface of the tube.

6. The tool of claim 1 further comprising a third accelerometer mounted to the tool body, the third accelerometer adapted to contact the inside surface of the tube at the first circumferential position and an axial position distinct from an axial position of the first accelerometer.

7. The tool of claim 1 further comprising a fourth accelerometer mounted to the tool body, the fourth accelerometer adapted to contact the inside surface of the tube at the second circumferential position and an axial position distinct from an axial position of the second accelerometer.

8. A method for locating a spacer surrounding a tube, the method comprising:
isolating a section of the tube;
exciting the isolated section of the tube with vibrations;
measuring resultant tube vibrations;
determining, from the resultant tube vibrations, tube vibration characteristics; and
analyzing the tube vibration characteristics to determine an axial location along the tube for the spacer.

9. The method of claim 8 wherein isolating the section of the tube comprises forcing first clamping members to apply pressure against an inside surface of the tube at a first end of the section and forcing second clamping members to apply pressure against the inside surface of the tube at a second end of the section.

10. A method for measuring load on a spacer surrounding a tube, the method comprising:
isolating a section of the tube;
exciting the isolated section of the tube with vibrations;
measuring resultant tube vibrations;
determining, from the resultant tube vibrations, tube vibration characteristics; and
analyzing the tube vibration characteristics to determine a load on the spacer.

11. The method of claim 10 wherein isolating the section of the tube comprises forcing first clamping members to apply pressure against an inside surface of the tube at a first end of the section and forcing second clamping members to apply pressure against the inside surface of the tube at a second end of the section.

12. A system comprising:
a control system;
an umbilical cable; and
a tool connected to the control system by the umbilical cable, the tool including:
a tool body;
a first clamping block assembly located at a first end of the tool body, the first clamping block assembly including first clamping members that, when actuated, apply pressure against an inside surface of the tube;
a second clamping block assembly located at a second end of the tool body, the first clamping block assembly including second clamping members that, when actuated, apply pressure against the inside surface of the tube;
a bearing pad mounted so as to contact the inside surface of the tube when the tool has been positioned within the tube;
an actuator adapted to apply, via the bearing pad, a vibratory force to the inside surface of the tube when the tool has been positioned within the tube;
a first accelerometer mounted to the tool body, the first accelerometer adapted to contact the inside surface of the tube at a first circumferential position when the tool has been positioned within the tube;
a second accelerometer mounted to the tool body, the second accelerometer adapted to contact the inside surface of the tube at a second circumferential position when the tool has been positioned within the tube, the second circumferential position approximately diametrically opposed to the first circumferential position; and
wherein the umbilical cable is adapted to transfer instructions from the control system to the tool and adapted to transfer output from the accelerometers to the control system.

13. The system of claim 12 wherein the instructions comprise instructions to the first clamping block to force the first clamping members to apply pressure against the inside surface of the tube and instructions to the second clamping block to force the second clamping members to apply pressure against the inside surface of the tube.

14. The system of claim 12 wherein the control system is adapted to determine, from received output from the accelerometers, tube vibration characteristics.

15. The system of claim 14 wherein the control system is adapted to analyze the tube vibration characteristics to determine an axial location along the tube for an annulus spacer.

16. The system of claim 15 wherein the control system is adapted to analyze the tube vibration characteristics to determine a load on an annulus spacer.

17. The system of claim 16 wherein the tube vibration characteristics comprise natural frequencies.

18. The system of claim 16 wherein the tube vibration characteristics comprise vibration amplitude at the axial location of the annulus spacer.
